(19) United States
(12) Patent Application Publication
(10) Pub. No.: US 2009/0076891 A1
(43) Pub. Date: Mar. 19, 2009

(54) SYSTEM FOR ELECTRONIC VOTING USING A TRUSTED COMPUTING PLATFORM

(76) Inventors: Richard J. Cardone, Austin, TX (US); Michael A. Halcrow, Pflugerville, TX (US); Benjamin M. Landman, Cedar Park, TX (US); Kent Yoder, Austin, TX (US)

Correspondence Address: IBM CORPORATION, T.J. WATSON RESEARCH CENTER, P.O. BOX 218, YORKTOWN HEIGHTS, NY, 10598, US

(21) Appl. No.: 11/854,859

(22) Filed: Sep. 13, 2007

(51) Int. Cl. G07C 13/00

(52) U.S. Cl. 705/12; 235/386

(57) ABSTRACT

An apparatus for executing a trusted electronic voting system under the control of an election authority comprising: at least one electronic voting machine; an election configuration for the voting machine in the electronic voting system; and a trusted computing platform for the voting machine in the electronic voting system.

### CROSS-REFERENCE TO RELATED APPLICATIONS

Cross reference is made to the following co-pending, commonly assigned, US patent applications which were filed concurrently with this application: U.S. Ser. No. AA/AAA,AAA entitled “System for paper Free Verifiable Electronic Voting” (Atty. Docket Number YOR920070507US1); U.S. Ser. No. BB/BBB,BBB entitled “Method for Paper Free Verifiable Electronic Voting” (Atty. Docket Number YOR920070507US2); and, U.S. Ser. No. DD/DDD,DDD entitled “A Method for Electronic Voting using a Trusted Computing Platform” (Atty. Docket Number YOR920070531US2); whose content is incorporated herein by reference in its entirety.

### FIELD OF THE INVENTION

The present invention generally relates to electronic voting and more particular an apparatus for electronic voting using a trusted computing platform.

### BACKGROUND

Today's electronic voting systems, whether they are direct-recording electronic (DRE) systems or optical scan systems, are often built using proprietary hardware and software. Some DRE systems, for example, use touch screen displays for capturing voter input on systems that run the Microsoft Windows™ operating system. To meet legal requirements for use in public elections, voting systems are typically verified beforehand by independent testing labs, which labs are licensed by government and contracted by manufacturers under non-disclosure agreements. Voting systems usually incorporate commercially available operating systems and other off-the-shelf software that, by law, is outside the verification testing performed by the independent labs.

This approach of using proprietary voting system hardware and software that are not available for public scrutiny, in conjunction with tens of millions of lines of unverified operating system and related code, has led to well-documented security exposures and to incidents in which voting systems have failed during public elections. So far, no reported failures of voting systems in U.S. public elections were do to malicious intent, such as a software virus or sabotage by an election worker, but the use of standard, commercial operating systems in an unverified environment does expose voting systems to those risks.

### SUMMARY

This invention addresses the security risks in current voting systems by applying trusted computing technology to all computing devices in an electronic voting system. The invention also provides for secure, authenticated communication between devices in a voting system and allows for various configurations of those devices. Since the execution environment of each device is attested each time the device runs, commodity hardware can be safely used as the basis of voting systems. These systems can also include non-proprietary or open source software.

A minimal electronic voting system consists of one or more input devices by which voters record their votes. The main functions performed by such an input device are to present each voter with an appropriate ballot, to allow the voter to enter and review his or her selections, and then to record the selections while preserving voter anonymity as required by the rules of the election. An electronic voting system can also perform other voting related tasks using electronic computing components.

Vote tallying entails the accurate counting of all votes on all valid ballots. Voter validation entails checking that each voter is authorized to vote in the election based on the rules that govern the election. A voter registration database stores information about registered voters and their eligibility to vote in elections.

The vote tallying, voter validation, voter input functions are often implemented on separate devices, though this is not a requirement and various functions can be combined on one device. Similarly, the voter registration database can be located on hardware that also houses one or more of the other system functions. In addition, multiple installations of the database can exist across multiple polling places and these installations may or may not contain precisely the same information.

The present invention works by requiring that each electronic computing device that is part of an electronic voting system execute as a trusted computing platform, and that each such device only communicates with other trusted computing platforms over secure channels. A trusted computing platform can at any time use cryptographic means to accurately report its state, which can then be verified to determine the platform's integrity. Trusted computing platforms typically include a tamper-resistant microprocessor that measures the state of the machine, maintaining a log of all software that has run on the machine since the machine was turned on. This microprocessor can cryptographically sign the log and bind data to this log, so that a third party can have assurance that the machine only ran trusted software from the time it booted up until the time the measurement was taken.

The most prominent example of such a microprocessor is the Trusted Platform Module (TPM), which has been standardized by the Trusted Computing Group™ (https://www.trustedcomputinggroup.org). The TPM forms the basis of a trusted computing platform by protecting against virtual and physical attacks. The TPM is a microprocessor that can be embedded into a device, such as the motherboard of a personal computer or server. This embedded chip securely stores digital keys, certificates, and passwords. The chip also includes a random number generator and the ability to perform certain cryptographic operations, such as the generation of new keys.

By running on a trusted computing platform, each device in an electronic voting system operates in a verified environment such that, at any point in time, only known and uncorrupted software is loaded into memory and executed. Moreover, each device can attest to its state and communicating devices can perform mutual attestation to verify to each other that both devices are in a valid state before communicating. Using this secure foundation, a trusted electronic voting system can accurately capture, count, and report the votes cast in an election.

In one aspect of the present invention, shown is an apparatus for executing a trusted electronic voting system under the control of an election authority comprising: at least one electronic voting machine; an election configuration for the voting machine in the electronic voting system; and a trusted computing platform for the voting machine in the electronic voting system.

In yet another aspect of the present invention, the voting system comprises a tally module as part of the voting machines.

In yet another aspect of the present invention, there is a procedure to detect whether the voting machines are in the election configuration.

In yet another aspect of the present invention, there is a procedure to exclude from an election any the voting machine that is not in the election configuration.

In yet another aspect of the present invention, a pre-election process is controlled by an election authority that uses a device registration server to establish the election configuration for the voting machines in the electronic voting system.

In yet another aspect of the present invention, the voting system comprises a device registration server, whereby the device registration server is used to issue cryptographic certificates and keys to the voting machines.

In yet another aspect of the present invention, the device registration server can use a communication channel to distribute previously issued certificates and keys during an election.

In yet another aspect of the present invention, the election configuration specifies the precise firmware and software that the voting machines must run during the election.

In yet another aspect of the present invention, the trusted computing platform is implemented using open source software and commodity hardware.

In yet another aspect of the present invention, certification of components of the electronic voting systems is performed by a consortium of technical experts whose work product is freely and publicly available.

In yet another aspect of the present invention, the voting system comprises at least one ancillary device that runs on a trusted computing platform which can interact using a communication channel with other devices, including the voting machines, of the trusted electronic voting system. The ancillary device can be, but is not limited to, a tally server, a voter validation server, a voter registration database, a device registration server, a printer, a biometric reader, a bar code reader, a portable storage reader, or a smart card reader.

In yet another aspect of the present invention, communication between the devices during an election only takes place if each of the devices is communicating in the election configuration.

In yet another aspect of the present invention, the voting system comprises one or more communication channels allowing the devices to exchange data with cryptographically guaranteed integrity.

In yet another aspect of the present invention, the devices execute as trusted computing platforms that conform to a standard specification for trusted computed platforms.

### BRIEF DESCRIPTION OF DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a standalone voting machine;

FIG. 2 is a block diagram of voting machines with separate tally server;

FIG. 3 is a block diagram of voting machines with local tally storage and separate tally server;

FIG. 4 is a flow diagram depicting casting a ballot with separate tally server (Immediate Transmission);

FIG. 5 is a flow diagram depicting casting a ballot with separate tally server (Batch Transmission);

FIG. 6 is a flow diagram depicting casting a ballot with separate tally server (Store and Forward);

FIG. 7 is a block diagram of voting machines with a voter validation server;

FIG. 8 is a flow diagram depicting casting a ballot on a voting machine with a voter validation server;

FIG. 9 is a block diagram of voting machines with a tally server and a voter validation server;

FIG. 10 is a block diagram of voting machines with a tally server and a voter validation server connected via a wired or wireless network;

FIG. 11 is a flow diagram depicting a voter using a voter validation system and a tally server.

FIG. 12 is a block diagram of a voter validation system with a remote database;

FIG. 13 is a flow diagram depicting validating a voter using a remote database;

FIG. 14 is a flowchart illustrating the steps that must be taken during the physical machine registration phase;

FIG. 15 is a flowchart illustrating the portion of taking ownership that can be done without physical presence of the owner;

FIG. 16 is a flowchart illustrating the steps that are taken when casting a ballot during an election; and

FIG. 17 is a block diagram depicting a voting system having voting machines, voter validation server, a tally server, a voter registration database, and an ancillary device.

### DETAILED DESCRIPTION

The function of a Trusted Computing Platform (TCP) is to securely and accurately record the software state of a platform and to report that state to other platforms in a verifiable way. In this context, platform usually corresponds to a device. The Trusted Computing Group™ (TCG), TCG has delivered a set of standards that have been used to implement all the components necessary to achieve a TCP. The following description of a TCP can be implemented using TCG standardized components or any other methodology that achieves the same ends.

Each TCP includes a statistically unique asymmetric key pair, either generated at machine manufacture time or after delivery to the customer, which we'll call the platform key. The platform key is used for public key cryptography and includes a public and private part. The private part of the key pair should not be discoverable by system software, but operations using the key such as encrypt, decrypt, sign and verify, should be allowed. This can be accomplished either by providing a tamper resistant piece of hardware containing the key, or in a virtualized OS environment, a specialized software partition with the necessary functionality.

The platform key represents a root of trust on which all system validation depends. A root of trust uses cryptographic techniques to protect the system from software attacks. Hardware attacks, however, are countered by keeping the system physically secure. Trust is extended from the root to higher layers of system firmware and software by establishing a chain of trust from one layer to the next. This chain of trust starts at the root, which verifies the first layer of system firmware/software. This verified layer then verifies the next layer of firmware/software and the process continues until all components of the trusted computing platform are included.

For example, the root of trust in a personal computer can be a tamper resistant chip, such as a TPM, that includes the platform key. When the machine boots, this chip verifies itself and the first layer of firmware or software, which then verifies the next layer of firmware/software and so on. In a trusted electronic voting system, the chain of trust would start at the platform key and include, in order, the BIOS, the OS loader, the OS, and the voting application. Except for the root, each link in this chain is verified by its predecessor.

A Trusted Third Party (TTP) can use the system-specific platform keys to help one platform verify that another platform is a TCP. This process involves the TTP issuing a trusted certificate to each trusted platform once those platforms have proven their support for the required trusted computing features. The trusted certificate associates the public part of a platform key with its platform and represents the TTP's confidence that the platform is a TCP.

The TCP maintains a comprehensive list of the software that has been executed on the machine, called a software integrity log. This list includes all software executed after the machine is in a known secure state, such as immediately before the BIOS of the machine begins to execute, or, if a trusted hypervisor is used, after the hypervisor has loaded. When requested by a challenger, that is, another machine that wants to verify the trust state of a trusted computing platform, the TCP provides the software integrity log in an agreed upon format. The queried TCP signs the log using its private key and the challenger verifies the signature using information in the trusted certificate.

Specifically, the challenger compares the software integrity log returned by the TCP to a reference integrity log associated with that TCP. The reference log, which can be part of the trusted certificate created by the TTP, represents the expected configuration for a TCP. In voting systems, we call this expected configuration the device's election configuration. A challenger, once armed with a TCP's trusted certificate and reference log, is ready to verify a TCP's identity and configuration. Using the trusted certificate and TCP signature, the challenger verifies the identity of the TCP and the integrity of the software log returned by the TCP. Using the verified software integrity log, the reference integrity log, and other software integrity metrics returned by the TCP, the challenger validates that only expected, unmodified, trusted programs have been executed on the TCP.

This process of requesting and receiving all the data necessary to determine if a platform is trustworthy is called quoting and this process allows a device to attest its trustworthiness to another device. In voting systems, a mutual attestation protocol is used so that the trustworthiness of both devices is established before data is exchanged. Once both devices are known to be in a trusted state, a secure connection can be established between them.

An election is administered by an election authority, which in public elections is the governmental agency, such as the County Clerk, entrusted by law to collect votes in a geographic jurisdiction in a prescribed manner. The election authority divides its jurisdiction into precincts and the people that reside in the same precinct vote at the same polling place. Each precinct has one or more poll workers responsible for setting up and running the election in the precinct. We call the head poll worker at each precinct the precinct judge. For simplicity, assumed is a one-to-one correspondence between precincts and polling places, though this is not always the case.

The following are definitions for the main components of a trusted electronic voting system:

A Voting Machine is a device that executes as a trusted computing platform and allows voters to securely make selections and cast ballots. This device can receive input and present output in any way required by human voters. For example, these input and output modalities can include, but are not limited to, output-only displays, touch-screen displays, pointing devices, scrolling devices, electronic pens, printers, speech interfaces, and tactile interfaces. A voting machine captures voter intent by saving or transmitting ballot information. Voting machines can include backup power supplies and tamper-resistant hardware features to provide high levels of physical security and reliability.

A Voting Application is application software that runs on a voting machine and, at a minimum, provides the interface through which voters make selections and cast ballots. Typically, applications also provide administrative functions. The voting application is always part of the trusted computing platform of the device on which it executes.

A Tally Module is a component that aggregates the selections made by multiple voters in an election. Tally modules process cast ballots and can reside on dedicated hardware or on hardware shared with other components. A tally module always executes on trusted computing platform and is always part of that platform.

A Trusted Third Party Server (TTPS) is a component that executes on a trusted computing platform to provide identification services to other components of the trusted electronic voting system. The TTPS is a mandatory component that can be used in an online or offline way. In either case, the public key of the TTPS is known to all other components of the trusted electronic voting system. The main function of the TTPS is to store identity information about system components and to generate trusted certificates for system components. The TTPS can be run and managed by the election authority.

A Device Registration Server is another name for the Trusted Third Party Server (TTPS) when used in a trusted electronic voting system.

A Voter Validation Module is a component that determines whether a particular voter is eligible to vote in an election. This module may perform both voter authentication and voter authorization functions. Authentication involves identifying a voter. Authorization involves verifying whether an identified voter is eligible to vote at a particular place and time, using a particular voting procedure, in a particular election.

The voter validation module is an optional part of a trusted electronic voting system. If the module is part of the trusted electronic voting system, then it executes as part of a trusted computing platform. As part of the trusted electronic voting system, the validation module may or may not interact directly with other system components, such as voting machines or tally modules. Alternatively, voter validation can be performed completely outside of the trusted electronic voting system, such as by manually looking up voter names in a registration book.

A Shared Voter Registration Database is an optional component can be used to share voter registration and status information with multiple voter validation modules. When a shared database is used, voter validation modules can dynamically communicate with the database to verify the eligibility of a voter. The shared voter registration database executes as part of a trusted computing platform whenever the database is used.

Described below are various configurations of precinct electronic voting systems that run on a trusted computing platform. As can be appreciated, these configurations are not the only possible configurations for voting systems under the present invention, but they illustrate potential scenarios. Computing devices that appear in a configuration of this invention conform to the following central design principle: During an election, any computing device that is part of the voting system either initializes as a trusted computing platform in its election configuration or does not initialize at all. Each transaction between devices proceeds only after they have mutually attested their identity and election configuration. Any data exchanged between devices during an election have their integrity and, where necessary, their confidentiality cryptographically protected.

Any system that satisfies the above conditions is a Trusted Electronic Voting System (TEVS).

In the example configurations below, it is assumed that the election authority has established ownership over each device; that the election configuration has been established for each device; that the TTPS public key is securely installed on each device; and that each device stores its device-specific, trusted certificate that was generated by the TTPS. This last assumption implies that there is no online TTPS is needed during an election.

If devices communicate during an election, it is assumed that all communication between devices in the trusted electronic voting system (1) occurs only after the communicating devices have mutually attested to each other, (2) the integrity of all transmitted data is cryptographically guaranteed, and (3) the confidentiality, if required, of all transmitted data is cryptographically guaranteed.

In a first exemplary configuration, one or more voting machines reside in a precinct. Each voting machine executes on an isolated trusted computing platform that performs all the input, output, record keeping, tallying, security, and administrative functions of a complete voting system.

Before an election, voting machine setup includes upgrading software, loading ballots, and updating then election configuration and trusted certificate if necessary. When the election is held, the voting software runs only if the machine boots into its election configuration. Authorized poll workers can perform administrator functions on each voting machine, including the following: start the machine; verify the election configuration; run an election; report election results; delete election results; and shutdown.

An administrator can be authorized to manage the voting machines using any well-known technique, including, but not limited to, the use of passwords, biometric authentication, physical keys, and encrypted tokens on portable media. During an election, various techniques can be used to control voter access to voting machines, including the use of temporary access codes, smart cards, or physical keys.

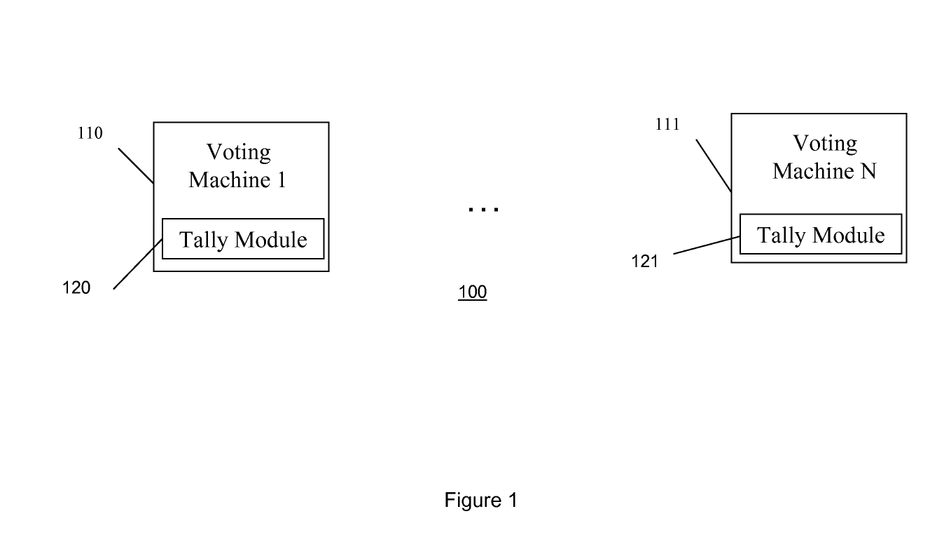

Turning now to the figures, FIG. 1 shows an Electronic Voting System 100 that comprises one or more voting machines 110, 111, each of which includes Tally Module 120, 121. The tally modules 120, 121 are housed inside the voting machines 110, 111 and serve to keep a count or tally of the votes cast by voters. In this standalone configuration, individual voting machines are responsible for tallying and securing the votes cast on them.

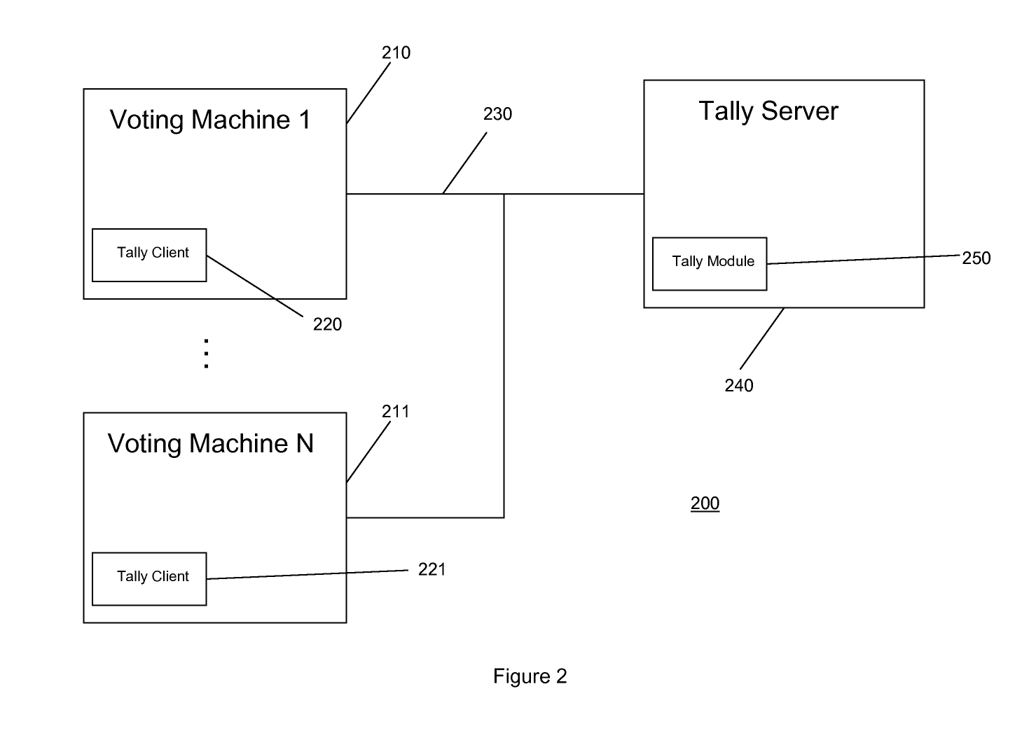

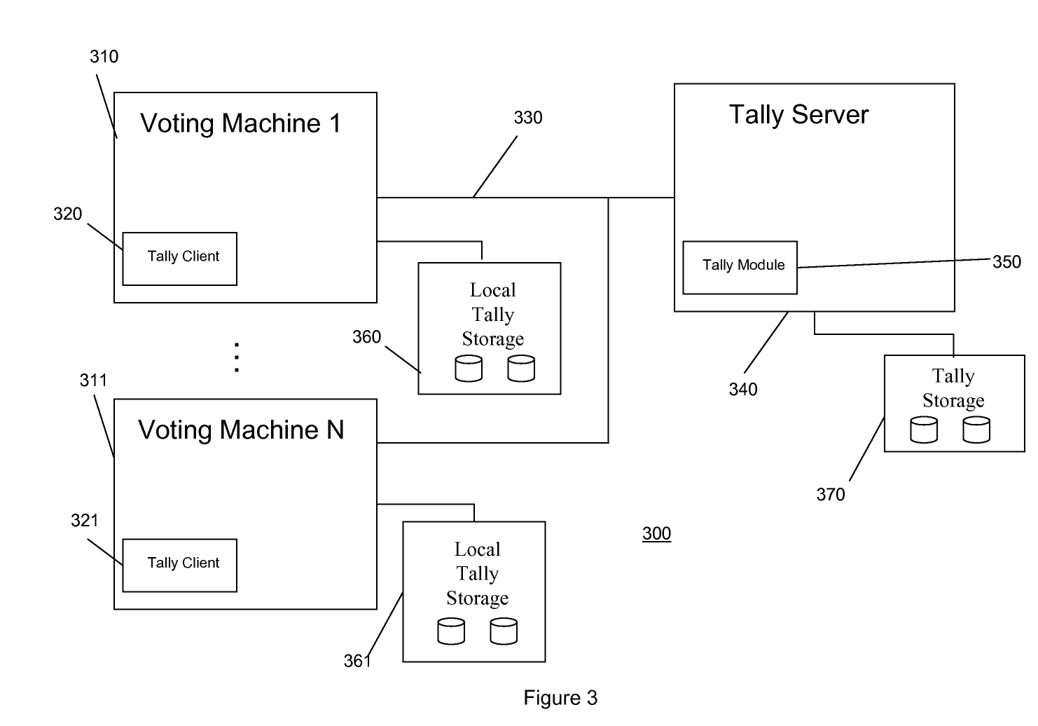

In additional configurations, as will be illustrated by FIGS. 2 and 3 below, one or more voting machines reside in a precinct along with a separate device, the tally server, on which the tally module resides. Each voting machine is connected to the tally server by some type of communication link, which may be wired or wireless. The voting machines provide the interface through which voters cast ballots and the tally server collects and tallies those ballots. The voting machines also contain a tally client, which manages the tally of votes cast on that machine.

During an election, the voting machines and the tally server either run as trusted computing platforms in their prescribed election configurations or they do not participate in the election. Different protocols can be used to transmit ballot information between voting machines and the tally servers. For example, when a voter cast a ballot on a voting machine, the voting machine can transmit the ballot information to the tally server and report the successful transmission to the voter. If transmission fails, the ballot information can be saved locally until transmission can be attempted again. Another option is for voting machines to store ballots locally until an administrator initiates the batch transmission of ballots. Yet another option would specify that ballots are both immediately transmitted and stored locally during an election. The critical requirement is to count all votes exactly once no matter what protocol is used.

FIG. 2 shows electronic voting system 200, comprising one or more voting machines, 210, 211, respectively, connected to a Tally Server, 240. The voting machines 210, 211 each contain a tally client, 220 and 221, respectively. A communication channel, or network connection 230 between the voting machines 210, 211 and tally server 240, can be a wired or wireless as described above. The Tally Server 240 includes a Tally Module 240 that counts the votes cast by voters.

FIG. 3 is similar to FIG. 2 in that it shows the configuration of electronic voting system 300 comprising multiple voting machines 310, 311, with a separate Tally Server 340. Each voting machine includes its own tally client 320, 321 In addition, each voting machine 310, 311 has a local storage component 360, 361, respectively, that stores tallied votes for that voting machine. The local storage may be implemented by flash memory, a disk system, or any other form of storage internal or external to the voting machine. At some later time, an administrator (not shown) may initiate a batch transfer of the tallied votes stored locally on voting machines to Tally Server 340. The Tally server 340 also has its own Tally Storage 370. The voting machines 310, 311 communicate over a shared medium 330, which is communication network.

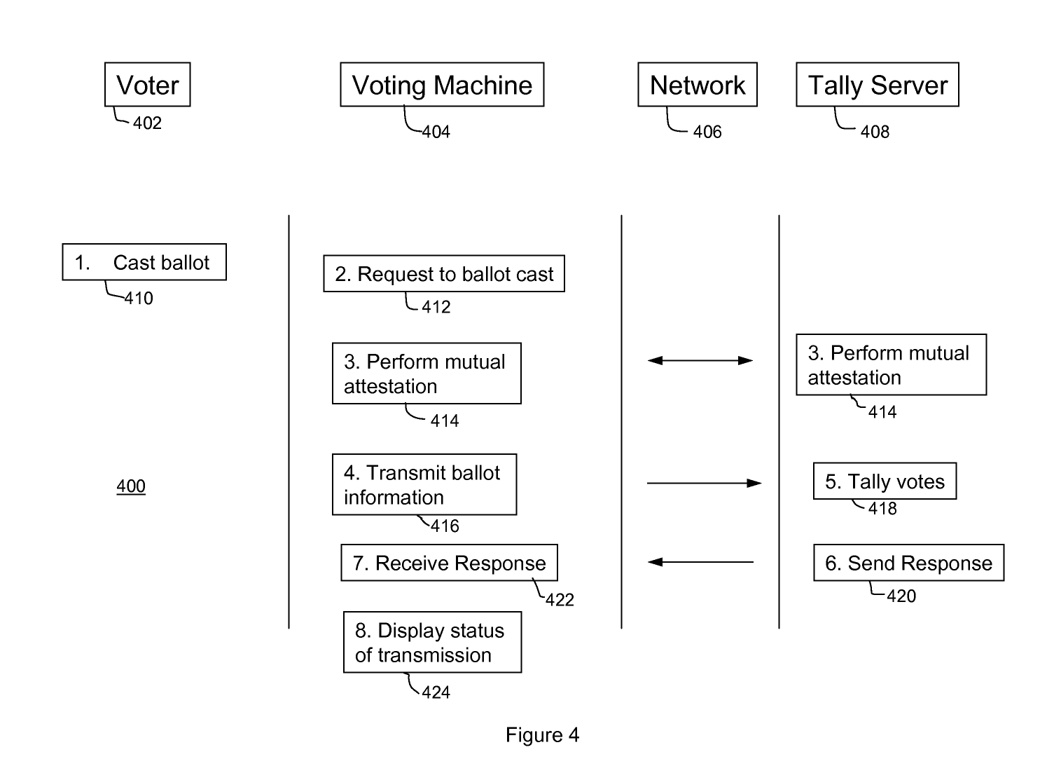

As mentioned above, the notion of mutual attestation is crucial to establishing a trust relationship between two systems. Mutual attestation is the process by which two systems demonstrate their integrity to each other. FIG. 4 is a flow diagram showing the process of a voter casting a ballot on a trusted electronic voting system 400 that uses a separate Tally Server, such as the systems shown in FIGS. 2 and 3. Electronic voting system 400 comprises voter 402, voting machine 404, network 406, and Tally Server 408. The process is initiated by voter 402 casting a ballot in step 410. In step 412, voting machine 404 receives the request to cast a ballot. Step 414 performs the mutual attestation between the voting machine 404 and the Tally Server 408 using network 406. Upon successful mutual attestation, the voting machine 404 transmits the ballot information in step 416. The Tally Server 408 will tally the votes in step 418 and send a response to the voting machine 404 over network 406 in step 420. The voting machine 404 receives the response from the Tally Server 408 in step 422 and displays the status of the transmission in step 424.

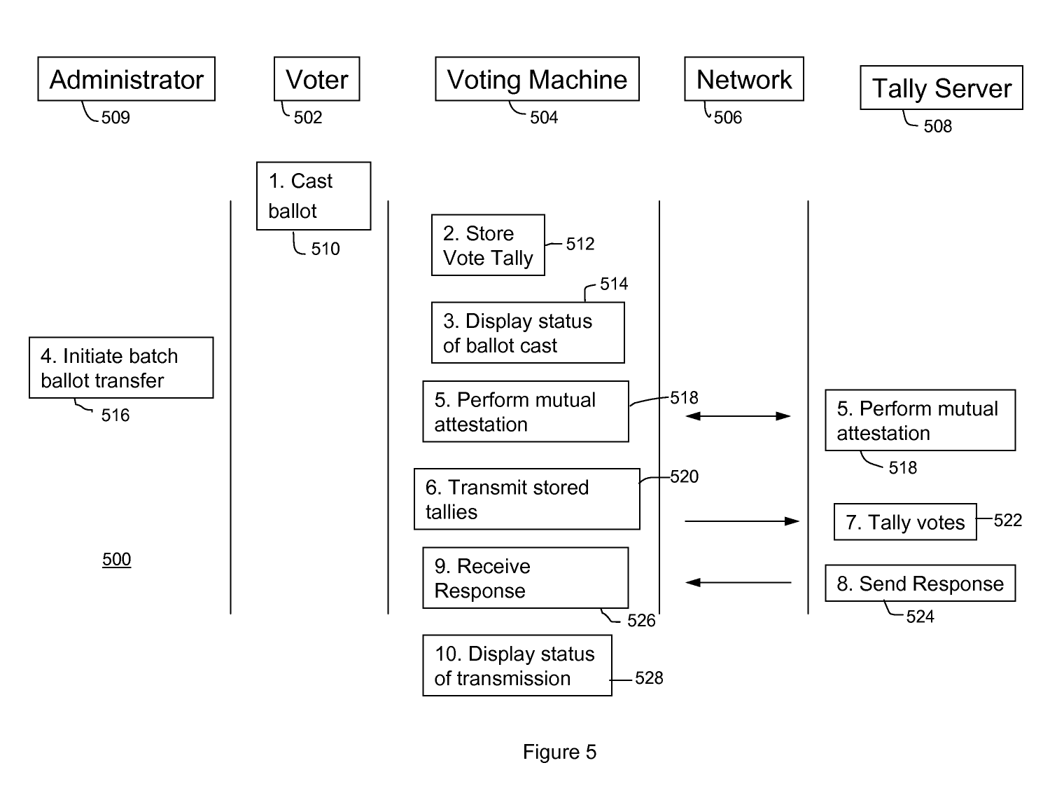

FIG. 5 is similar to FIG. 4, in that it captures the process of casting a ballot using a separate Tally Server. The process flow in FIG. 5, however, depicts the use of one possible store-and-forward protocol on voting machines that have local tally storage, such as voting machines 320 and 321 in FIG. 3. In FIG. 5, electronic voting system 500 comprises voter 502, voting machine 504, network 506, tally server 508 and administrator 509. Voter 502 casts a ballot in step 510. Step 512 shows voting machine 504, upon which the ballot was cast, storing the vote tally in its local tally storage. Step 514 displays the status of the ballot cast on voting machine 504 to voter 502. At some point during the election, possibly after voting has completed, administrator 509 initiates in step 516 a batch transfer of vote information to the Tally Server 508. Step 518 performs the mutual attestation protocol between the voting machine 504 and the Tally Server 508 over network 506. In step 520, the tallied votes stored locally on the voting machine 504 are transmitted to the Tally Server 508. The votes are tallied and stored on the Tally Server 508 in step 522, and a response is sent by tally server 508 to the voting machine 504 over network 506 in step 524. The voting machine 504 receives the response of the Tally Server 508 in Step 526 and displays the status of the transmission to the administrator in step 528. This setup would allow many voters to cast ballots, before the locally tallied votes are batch transferred to a Tally Server.

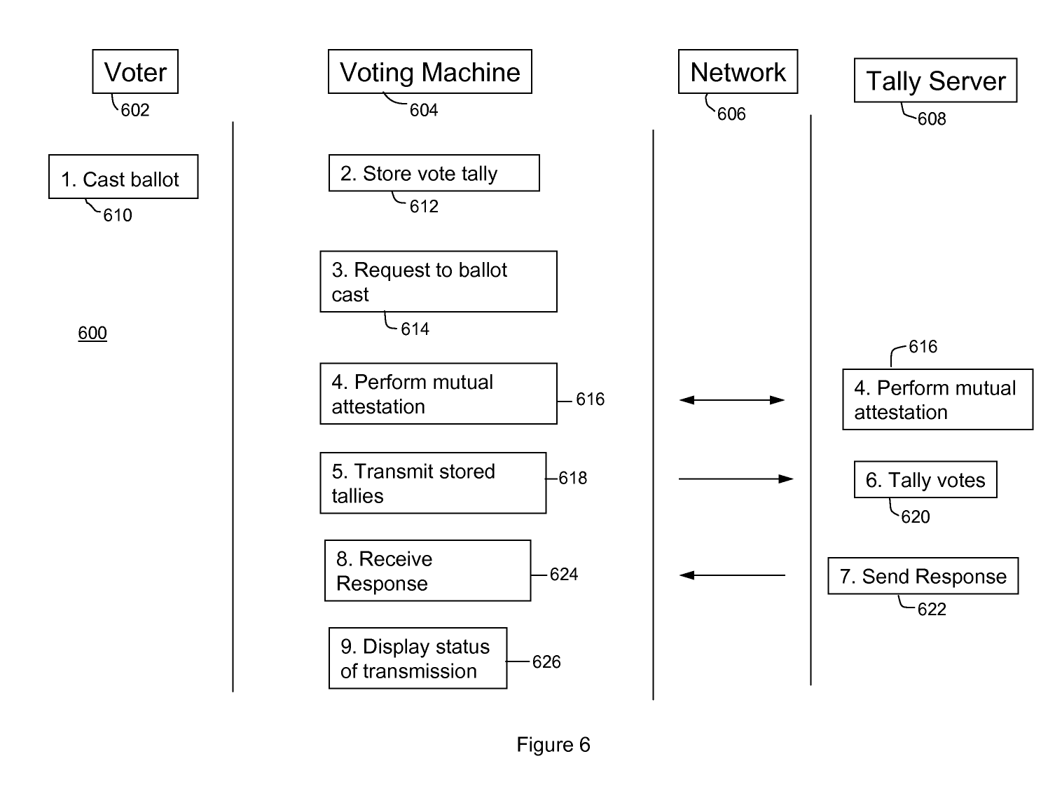

FIG. 6 shows electronic voting system 600 comprising voter 602, voting machine 604, network 606 and tally server 608. In relation to FIG. 5, rather than having an administrator initiate a batch transfer, the voting machine both stores local vote tally and automatically sends that tally to the Tally Server for each ballot cast. The process begins with voter 602 casting a ballot in step 610. In step 612, voting machine 604 stores a local vote tally. In step 614, voting machine 604 begins the cast ballot request with Tally Server 608. The first step of this request is to perform the mutual attestation protocol in step 616 between the voting machine 604 and the Tally Server 608 using network 606. When the mutual attestation protocol completes successfully, the ballot information for voter 602 is transmitted over network 606 in step 618 and tallied on the Tally server 608 in Step 620. The Tally Server 608 sends a response to the voting machine 604 in step 622 over network 606. The response is received by the voting machine 604 in step 624 and displayed to the voter 602 in step 626. At this point, voting machine 604 may or may not choose to erase the vote tally stored in step 2.

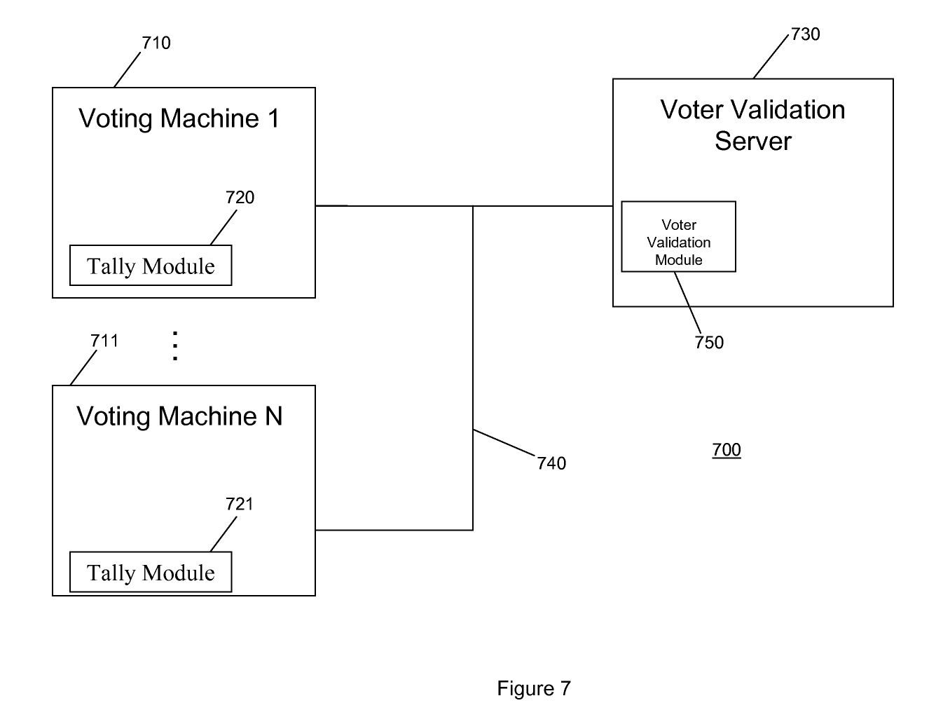

In the configurations shown in FIGS. 7-11, one or more voting machines reside in a precinct along with a separate device, the voter validation server, in which the voter validation module resides. Each voting machine is connected to the voter validation server by a communication link, which may be wired or wireless. The voting machines provide the interface through which voters cast ballots and the voter validation server authorizes a voter to use a machine. Each type of machine also implements the necessary administrative functions that permit machines of that type to be managed by authorized personnel.

During an election, the voting machines and the voter validation server either run as trusted computing platforms in their prescribed election configurations or they do not participate in the election. Different protocols can be used to transmit voter authorization information between voting machines and the voter validation server. For example, when a voter is authorized to vote, that voter's authorization can be sent by the voter validation server to a voting machine. The voter is then given an authorization token that the voting machine will verify, which allows the voter to vote on that machine. Another option is to give the voter an authorization token and allow him to use any voting machine. When a voter presents an authorization token to a voting machine, the voting machine sends a request to the voter validation server to check the authorization token. If the token is verified by the voter validation server, the voter can vote on that voting machine. The authorization token can be an access code that the voter enters into the voting machine, a smart card that the voter inserts into the voting machine, or any other method that uses a secret generated by the voter validation server. Authorization tokens usually have limited lifetimes.

Turning to FIG. 7, electronic voting system 700 comprises one or more voting machines 710, 711, with a Voter Validation Server (VVS) 730. Each voting machine includes a Tally Module 720, 721, that performs local tallies of ballots cast by voters. The voting machines 710, 711 are connected to the VVS 730 via a wired or wireless network 740. The Voter Validation Module 750 is the component of the VVS 730 that issues the authorization token.

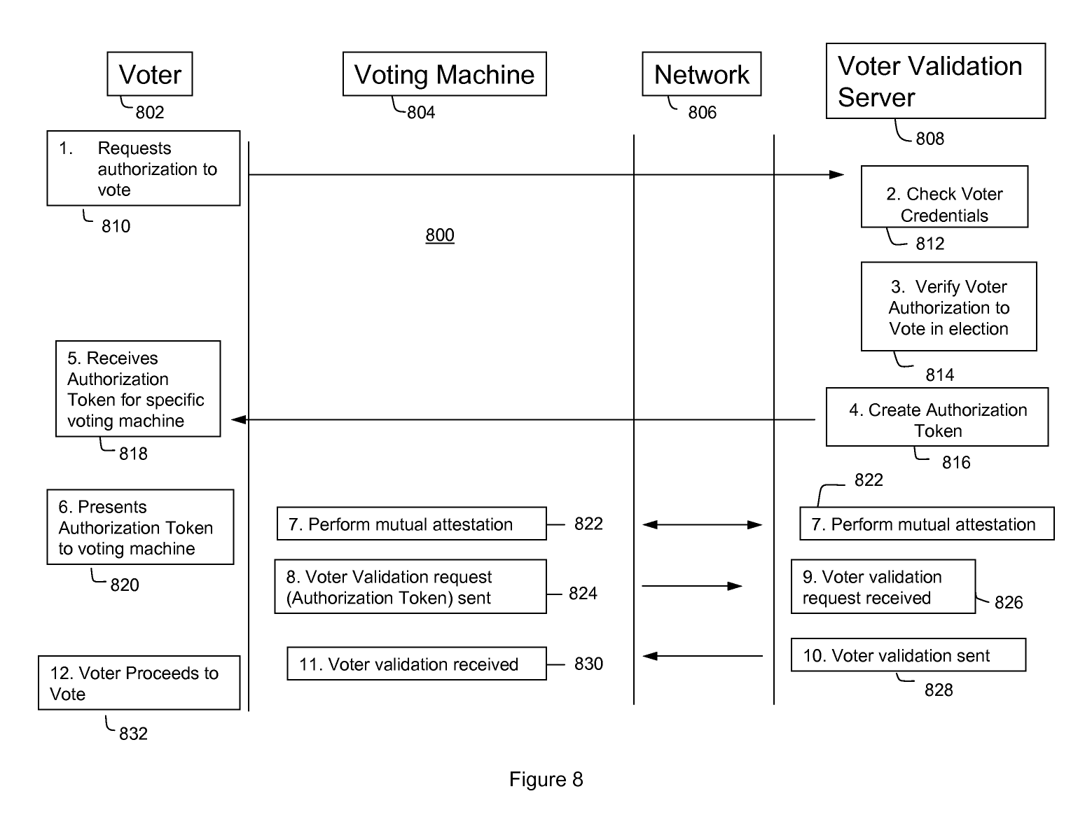

FIG. 8 is a flow diagram of electronic voting system 800 comprising voter 802, voting machine 804, network 806 and voter validation server (VVS) 808. Shown is the process where a voter casts a ballot using a voting system configuration as shown in FIG. 7. In FIG. 8, voter 802 requests authorization to vote in step 810. This request usually involves presenting some form of voter identification credentials, which are then checked in step 812. The credential checking process by which the voter gains authorization can vary. For example, the voter may directly interact with the VVS by submitting credentials to an input device attached to the VVS. A concrete example of such a system is one that allows a voter to scan a bar code from some official document, such as a voter registration card or a driver's license, into a bar code reader attached to the VVS. Alternatively, a voter could interact with an election worker who manually checks the voter's credentials. This manual approach would then have the election worker directly interact with the VVS to authorize the voter. Any number of credential checking processes can be imagined, including pre-election authorization processes and remote authorization processes, but regardless of the method used, a VVS is used to generate an authorization token.

Continuing with FIG. 8, after voter credentials are authenticated in step 812, the VVS verifies that the voter is authorized to participate in the election in step 814. In step 816, the voter is successfully authorized by the VVS and an authorization token is created. The Voter Validation module 750 in FIG. 7, a component of the Voter Validation Server, is the component that generates this authorization token. The token can take many forms including, but limited to: a printed receipt with a unique code, an encoded message sent to one or more voting machines in a precinct, a portable media device containing a digital token that can be inserted into a voting machine, or any other private information generated by the VVS. Tokens may have lifetimes associated with them to ensure that they are used within a certain time period. While not shown in FIG. 8, the unsuccessful completion of steps 812 or 814 can be handled in any number of ways, including but not limited to: an election worker notifying the voter of the failure, the VVS displaying a failure message to the voter, or the generation of an invalid token that indicates the authorization failure when voter attempts to vote.

Returning to FIG. 8, an authorized voter receives an authentication token for a specific voting machine in step 818. In 820, the voter presents the authorization token to the voting machine. Step 822 shows Voting Machine 804 and the VVS 808 performing the mutual attestation protocol before exchanging data. Upon successful completion of the protocol, the voting machine sends voter 802's authorization token to the VVS in step 824. The VVS 808 receives the token across network 806 from voting machine 804 in step 826. In step 828, the VVS validates the token and sends an approval message to Voting Machine 804 in step 830. At this point, Voter 802 can proceed to vote. Note that in step 826, the authorization token could fail validation for various reasons, including but limited to, if the token had been previously used, or if it expired, or if it had been corrupted in any way.

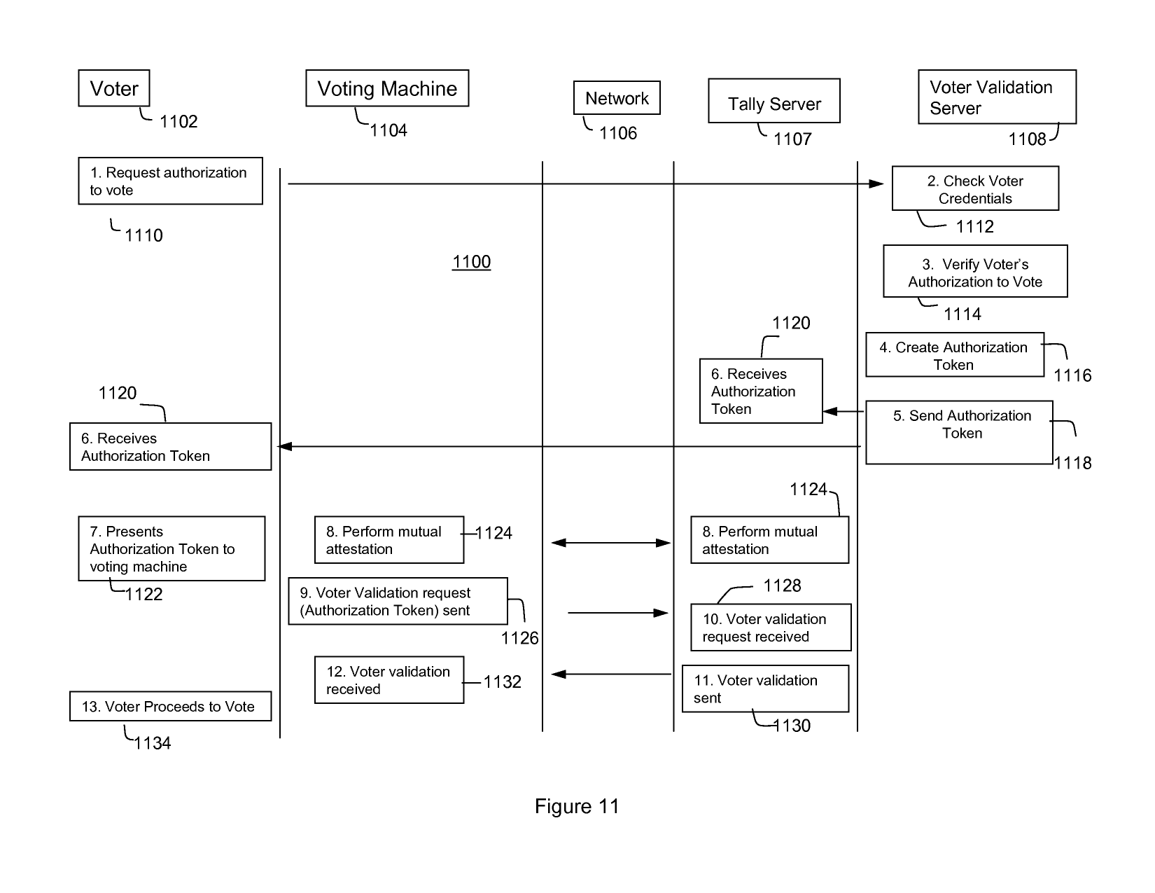

FIG. 8 further shows that the Voter 802 receives an authorization token for a specific voting machine 804. A less restrictive protocol, however, would allow a valid authorization token to be used on any voting machine in the precinct. Below, we examine one such protocol when we discuss FIG. 11.

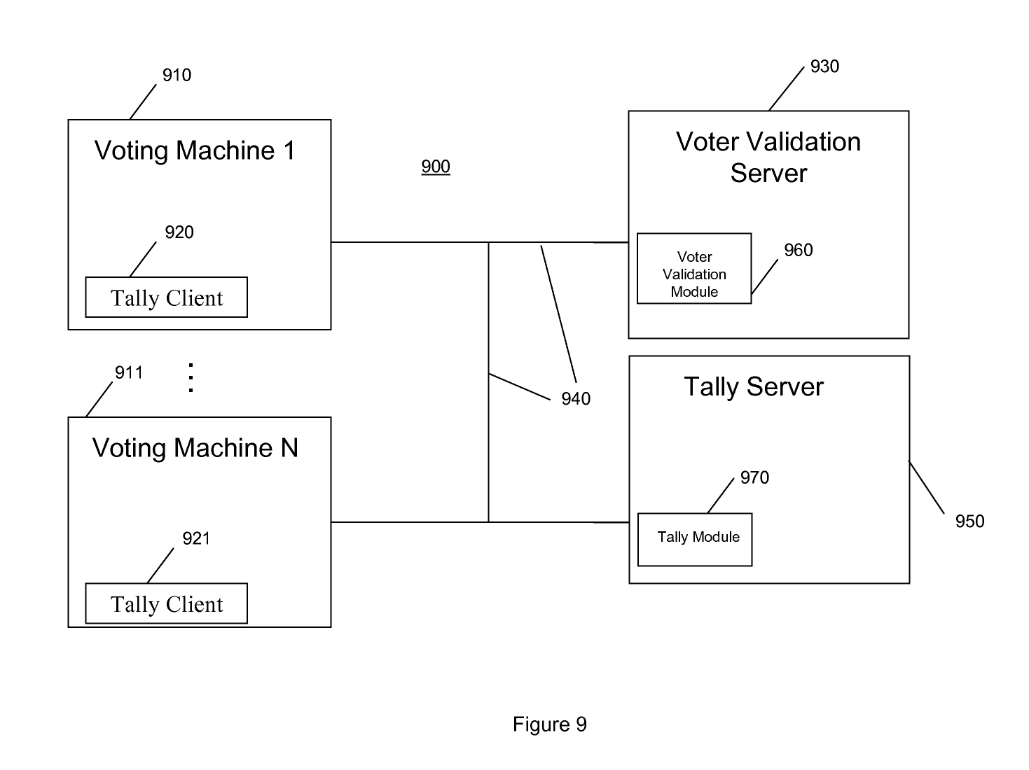

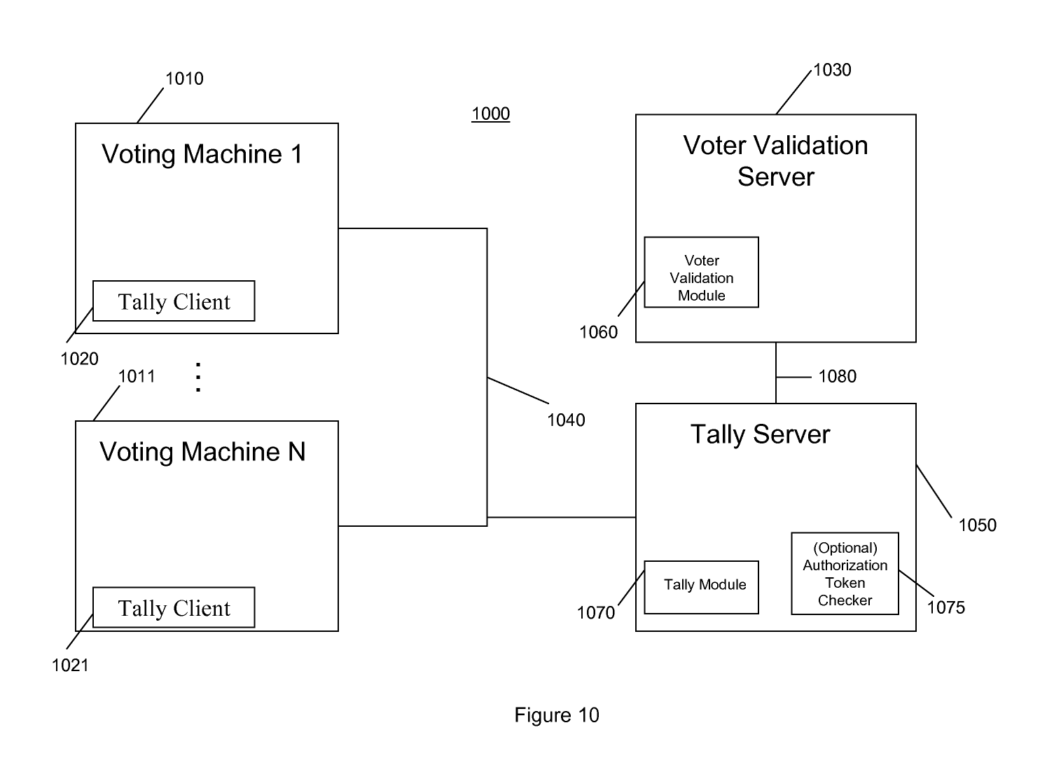

In the configuration shown in FIGS. 9 and 10, one or more voting machines reside in a precinct along with a separate tally server and separate a separate voter validation server. If the voting machines communicate directly with each type of server, then this configuration combines the elements of the systems shown in FIGS. 2-6. If, on the other hand, the voter validation server communicates only with the tally server, then a new communication pattern is created in which one server acts as a proxy for the other server.

In FIG. 9, electronic voting system 900 comprises one or more voting machines 910, 911 and includes both a Tally Server 950 and VVS 930. Voting machines, 910, 911, each include a tally client 920, 921. Voting machines 910, 911, communicate directly to both VVS, 930, and to Tally Server, 950, by a wired or wireless network 940. VVS 930 includes a Voter Validation Module 960. Tally Server 950 includes a Tally Module 970.

In FIG. 10, electronic voting system 1000 is similar to electronic voting system 900 shown in FIG. 9. Voting Machines 1010, 1011, have their own tally clients, 1020, 1021 respectively. VVS 1030 includes Voter Validation Module 1060. Tally Server, 1050, includes Tally Module 1070. A key difference between electronic voting systems 900 and 1000 of FIGS. 9 and 10, respectively, are the network connections. In FIG. 10, voting machines 1010, 1011 are connected to Tally Server 1050 via a wired or wireless network 1040. VVS 1030 is also connected to Tally Server 1050 via wired or wireless connection 1080. This network configuration shows that Voting Machines and the VVS do not directly communicate. Another important difference between FIGS. 9 and 10 is the optional inclusion of Authorization Token Checker 1075 in Tally Server 1050. The Authorization Token Checker validates authorization tokens, a task usually performed by a Voter Validation Module, such as Voter Validation Module 1060. When Authorization Token Checker 1075 is included in Tally Server 1050, Voting Machines 1010, 1011 communicate with Tally Server 1050 to validate an authorization token and no indirect communication with VVS 1030 is needed. When no Authorization Token Checker 1075 is included in Tally Server 1050, communication between Voting Machines 1010, 1011 and VVS 1030 must pass through intermediary Tally Server 1050 in order to validate an authorization token.

FIG. 11 shows the process flow 1100 associated with the voting configuration 1000 shown in FIG. 10 when the optional Authorization Token Checker 1075 is included in Tally Server. The process of voter authorization in FIG. 11 begins as does the process in FIG. 8. Voter 1102 requests an authorization to vote from the Voter Validation Server 1108 in step 1110. As in FIG. 8, the VVS 1108 checks the voter's credentials in step 1112. The VVS then verifies the voter's authorization to vote in step 1114.

Assuming that the voter is authorized to vote in this election at this precinct, an authorization token 1116 is created by the VVS 1108 in step 1116. The Authorization token is sent in step 1118 to both the Tally Server 1107 and the Voter 1102. Voter 802 receives the token in step 1120; at the same time, the Tally Server 1107 also receives the token in step 1120. Note that the physical realization of the token received by the voter and the token received by the Tally Server can different. For example, the voter can receive a paper receipt with the token represented as a bar code and the Tally Server can receive a digital token that encodes the information in the bar code.

Continuing with FIG. 11, voter 1102 presents the authorization token to Voting Machine 1104 in step 1122. Note that in this configuration, there are no constraints on which voting machine in the precinct that the voter can use. In step 1124, Voting Machine 1104 performs the mutual attestation protocol with Tally Server 1107. If the protocol completes successfully, Voting Machine 1104 sends the authorization token information to the Tally Server 1107 in step 1126. The Tally Server receives the request in step 1128 and processes it locally using its Authorization Token Checker. Assuming the token is still valid, the Tally Server responds in step 1130 with a voter validation approval message Voting Machine 1102 receives the validation approval response in step 1132 and voter 1102 proceeds to vote in step 1134.

Note that process 1100 does not require Voting Machines to interact during an election with a Voter Validation Server so that the server can generate authorization tokens prior to the election and be offline during an election. Under this approach, steps 1110 through 1120 in FIG. 11 would occur prior to the elections.

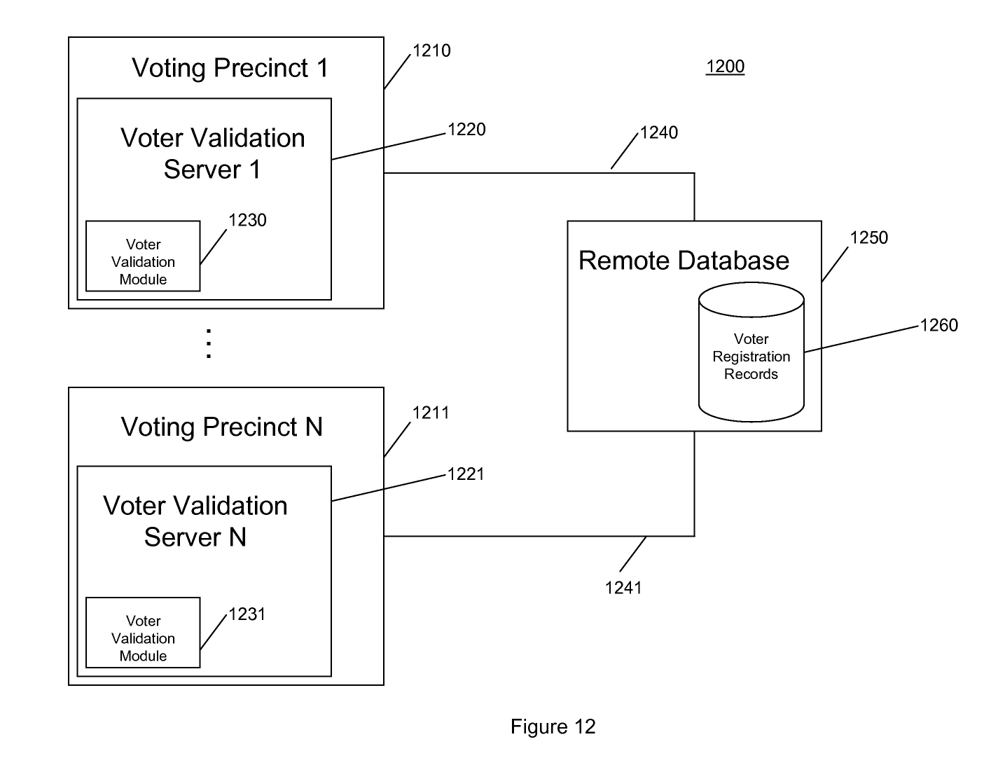

FIG. 12 shows a voter validation subsystem 1200 with a shared, remote database 1250. One or more voting precincts 1210, 1211 are shown. Each voting precinct includes its own Voter Validation Server, 1220, 1221, respectively. Each VVS 1220, 1221, has its own Voter Validation Module 1230, 1231 respectively. Voting precincts 1210, 1211 are connected via wired or wireless networks 1240, 1241 to the Remote Database in 1250. The Remote Database includes a set of Voter Registration Records 1260 that are used to determine who is eligible to vote in the election. VVSs 1230, 1231 query Remote Database 1250 to determine the eligibility of voters. If a voter is eligible, the voter is authorized by a VVS as described in FIGS. 7-11 and the voting process can continue. In addition, a VVS can mark a voter's registration record as “has voted” to prohibit a voter from voting multiple times in the same election. During an election, VVSs 1220, 1221 and Remote Database 1250 either run as trusted computing platforms in their prescribed election configurations or they do not participate in the election

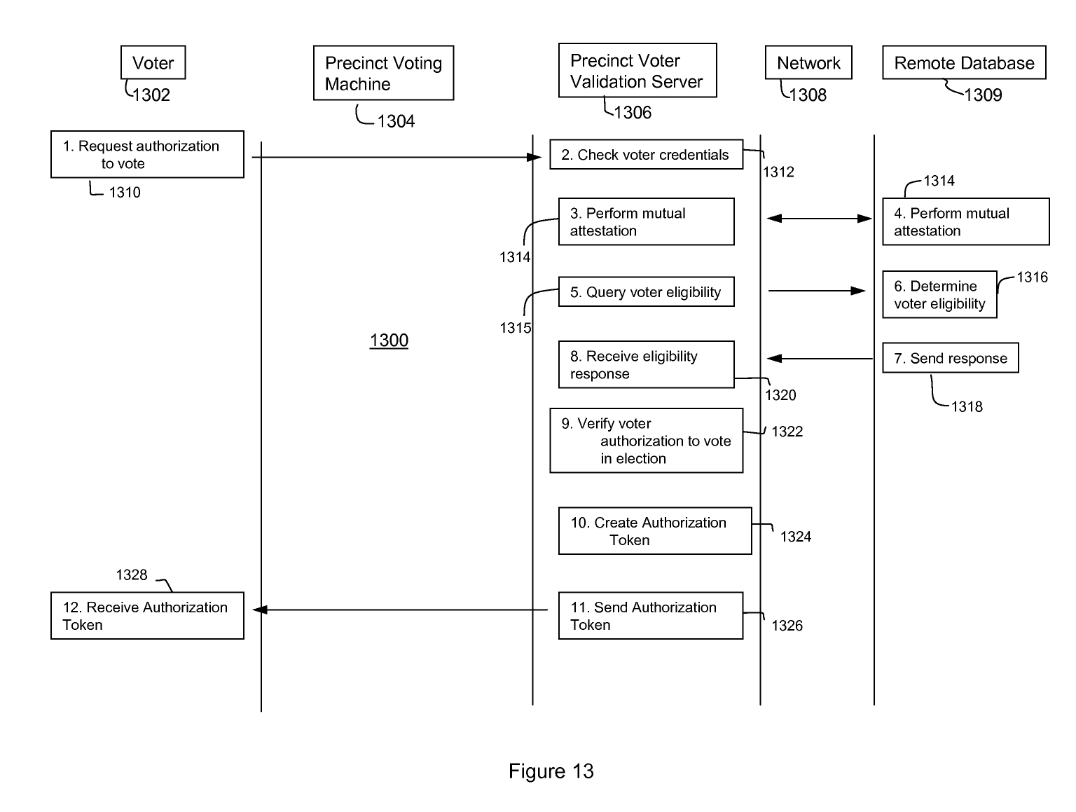

FIG. 13 illustrates the process of generating an authorization token for a voter, similar to the processes in FIGS. 8 and 11, except this time using a remote database as shown in FIG. 12. FIG. 13 shows an electronic voting system 1300 comprising Voter 1302, Precinct Voting Machine 1304, Precinct Voter Validation Server (PVVS) 1306, Network 1308 and Remote Database 1309. In step 1310, Voter 1302 requests authorization to cast a vote. This request usually involves presenting some form of voter identification credentials, as described in the FIG. 8 discussion. After PVVS 1306 authenticates the voter's credentials in step 1312, the PVVS needs to verify that the voter is authorized to participate in the election. PVVS 1306 initiates the mutual attestation protocol with Remote Database 1309 over network 1308 in step 1314. If the mutual attestation protocol succeeds, PVVS 1309 queries Remote Database 1309 about Voter 1302's eligibility to vote in this election in step 1315. In step 1316, the Remote Database receives the query, looks up the requested information, and transmits that information in response 1318. Assuming that the response in step 1320 indicates that Voter 1302 can vote in the election, PVVS 1308 verifies that Voter 1302 is authorized to vote in step 1322. In step 1324, PVVS 1308 creates an authorization token and in step 1326 send that token to the voter. In step 1328, Voter 1302 receives the authorization token and is ready to proceed in the voting process as previously described. Though not shown, step 1316 can also include setting a “has voted” flag in Remote Database 1309 to prevent a voter from voting multiple times.

In each of the systems shown above it can be appreciated that electronic voting system shown may comprise: one or more voting machines; one or more vote tallying components; one or more voter validation components; one or more voter registration databases; and a wired or wireless connections between some or all of the devices. The connection is often referred to as a network above, whereby the terms network and connections are interchangeable.

Following is a description of the operation of an electronic voting system operating on a Trusted Computing Platform (TCP). When a device that is part of a trusted electronic voting system is acquired from its manufacturer, the election authority that receives the device performs a procedure to take ownership of the device. Taking ownership comprises: recording the device's identifying information; associating some of the device's identifying information with the public part of the device's platform key; and marking the device as “owned.” The first two steps of the procedure are carried out using the trusted third party server (TTPS) defined above; the third step sets a state variable on the new device to indicate that the device is now owned.

After taking ownership of a device, the device is configured with all the hardware and software it requires for an election. The public key of the TTPS is also installed on the device or in some manner made accessible to the device. The device is then booted into its election configuration, which defines the execution environment of the device during an election. The election configuration starts with a root of trust and includes the chain of trust from that root to the voting application software that runs on the device. When the device is executing its election configuration, the device attests its configuration to the TTPS. The TTPS creates and stores a trusted certificate, which asserts that the device can participate in the trusted electronic voting system only when the device is in its election configuration. The device's reference log is included in the TTPS-generated certificate.

The following procedure allows devices to respond to quote requests during an election without relying on an online TTPS. The procedure requires that each device store its own trusted certificate. A device's trusted certificate includes all the information needed for the device to respond to a quote request from another device. When a quote is requested, a device responds by sending its certificate to the challenger along with its software integrity log, its current configuration measurements, and any other data required by the quote protocol. Given the trusted certificate, the challenger can verify the certificate's authenticity because it is signed by the TTPS. The challenger can then use the reference log in the certificate to validate the quoted device's current configuration.

For further authorization control, each device can also store a list of challenger devices that are authorized to request quotes from that device. This challenger list includes the public keys of all devices authorized to quote the device and is signed by the TTPS to guarantee its integrity. When a quote is received, the challenger's public key can be checked against the list of authorized challengers.

The following procedure allows devices to respond to quote requests during an election using an online TTPS. The procedure requires that each device store the trusted certificate of the TTPS and that the TTPS make available the trusted certificates of all devices upon request. The TTPS certificate includes the public key, reference log, and other information of the TTPS. Like all trusted certificates, the TTPS certificate is signed by the TTPS. Each device can compare the public key in the TTPS certificate with the TTPS public key previously installed on that device to make sure they match. When a device receives a quote request, either the receiving device or the challenger retrieves the receiving device's trusted certificate from the TTPS. Any interaction with the TTPS requires that the TTPS identify itself and attest to its configuration. Thus, a quote request to any device in the system can also require mutual attestation with the TTPS. Once the TTPS has attested, the requester can retrieve the trusted certificate of the device being quoted. Certificates can be cached on non-TTPS devices.

For further authorization control, the TTPS can also store a list of challenger devices for each device in the system. For device D, the challenger list for D includes all devices that are authorized to request quotes from D. When the TTPS receives request for D's trusted certificate, the request includes information that identifies the device challenging D. The TTPS guarantees that this challenger is listed in the D's challenger list before releasing D's trusted certificate.

During an election, only devices that can identify themselves and attest that they are in their election configuration can participate in the trusted electronic voting system. Whenever devices communicate online with one another each device attests to the other. Thus, online communication between devices in a trusted electronic voting system requires mutual attestation.

Offline communication, however, only requires that the sender attest to the receiver. An example of offline communication is when a source device writes data to portable media and one or more other devices read that media. In this case, the source device must in a cryptographically secure way associate the message payload with the source device's trusted certificate, its software integrity log, its current configuration measurements, and any other data required by the quote protocol.

In some implementations, the configuration of a communicating device can change after a quote has succeeded, but before data exchange has completed. In this situation, the quote protocol can be run again as part of a two phase transaction protocol after all data has been exchanged.

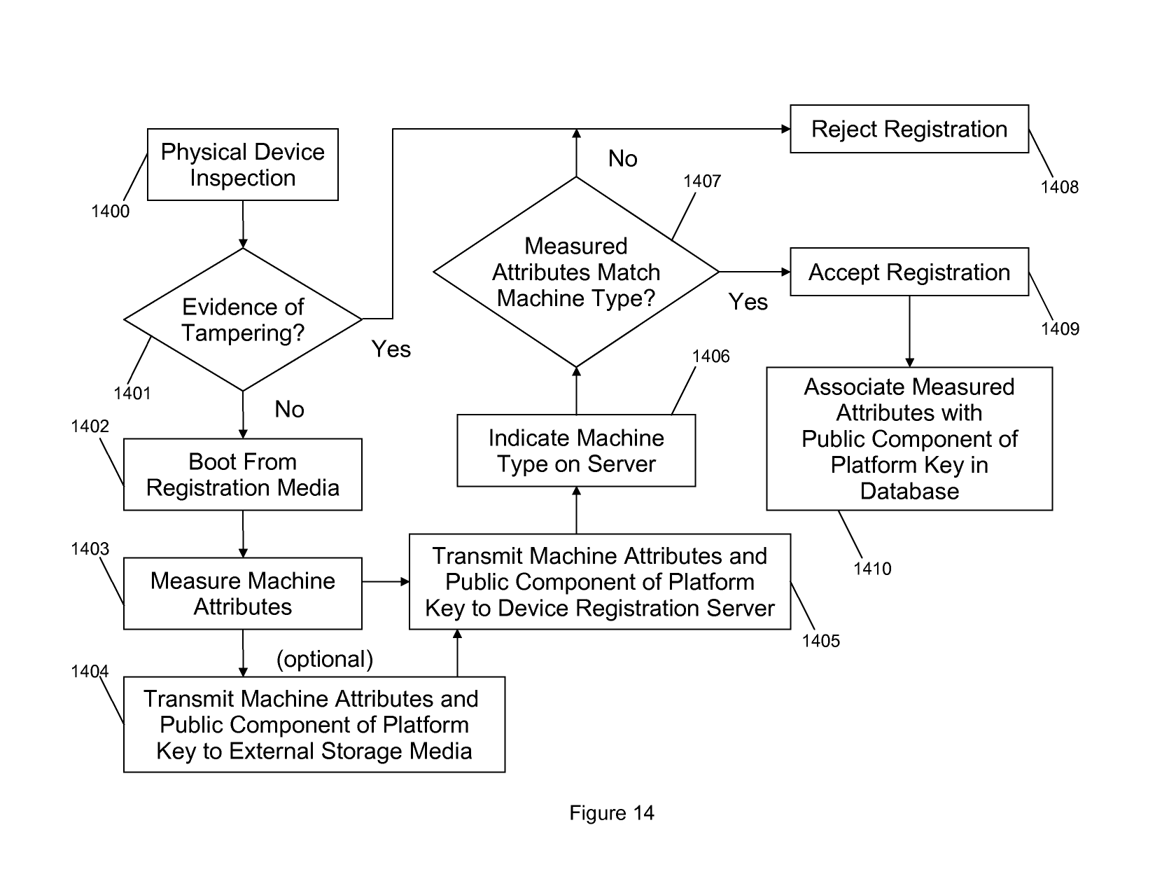

Turning back to the figures, FIG. 14 illustrates the steps that must be taken during the physical machine registration phase. During the physical device inspection, step 1400, if there is any evidence of tampering with the equipment, step 1401, then the registration of the device must be rejected, step 1408. If there is no evidence of tampering, then the registrar boots the machine with the registration media, step 1402. The registration software measures the characteristics of the machine, step 1403. These characteristics, along with the public component of the platform key, are transmitted to the device registration server, step 1405. This transmission may be done via a storage device, step 1404. The registrar then indicates via a user interface to the server what type of machine is being registered, step 1406. The server has pre-loaded a set of expected characteristics for the indicated machine type. If the measured characteristics match the pre-loaded expected characteristics, step 1407, then the device registration server accepts the registration request, step 1409, and records an association of the measures attributes with the public component of the platform key, step 1410. If, on the other hand, the measured attributes differ from the expected attributes, the device registration server rejects the registration request, step 1408.

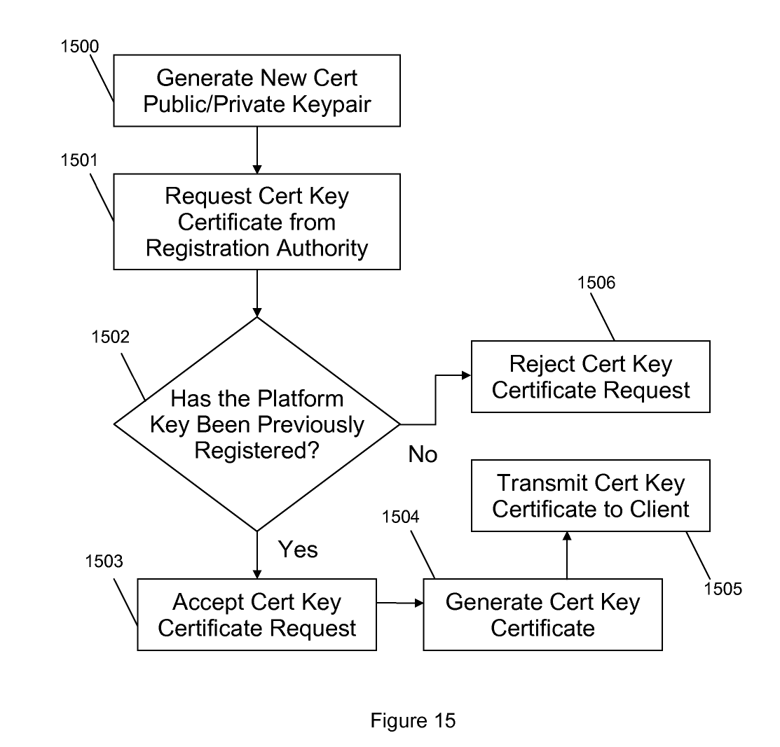

FIG. 15 illustrates the generation of auxiliary keys by a device. Auxiliary keys can be generated without requiring the owner of the device to be physically present, which is less restrictive than the taking ownership procedure discussed in FIG. 14. The client device generates a new Cert public/private key pair, step 1500, and requests the registration authority to generate a certificate for the Cert Key, step 1501. The registration authority checks its database to determine that the platform key used in the request has been successfully registered via the physical device registration process, step 1502. If a valid registration is found, then the device registration server accepts the certificate generation request, step 1503, generates a new certificate on the Cert Key, step 1504, and transmits the Cert Key certificate to the client device, step 1505. Otherwise, the device registration server rejects the Cert Key certificate request, step 1506.

Devices that have mutually attested to each other can communicate with integrity and confidentiality by generating a shared session key in the conventional way. Offline communication in which a device writes information for other devices to read at a later time can also be secured using conventional cryptographic means, such as by using asymmetric keys.

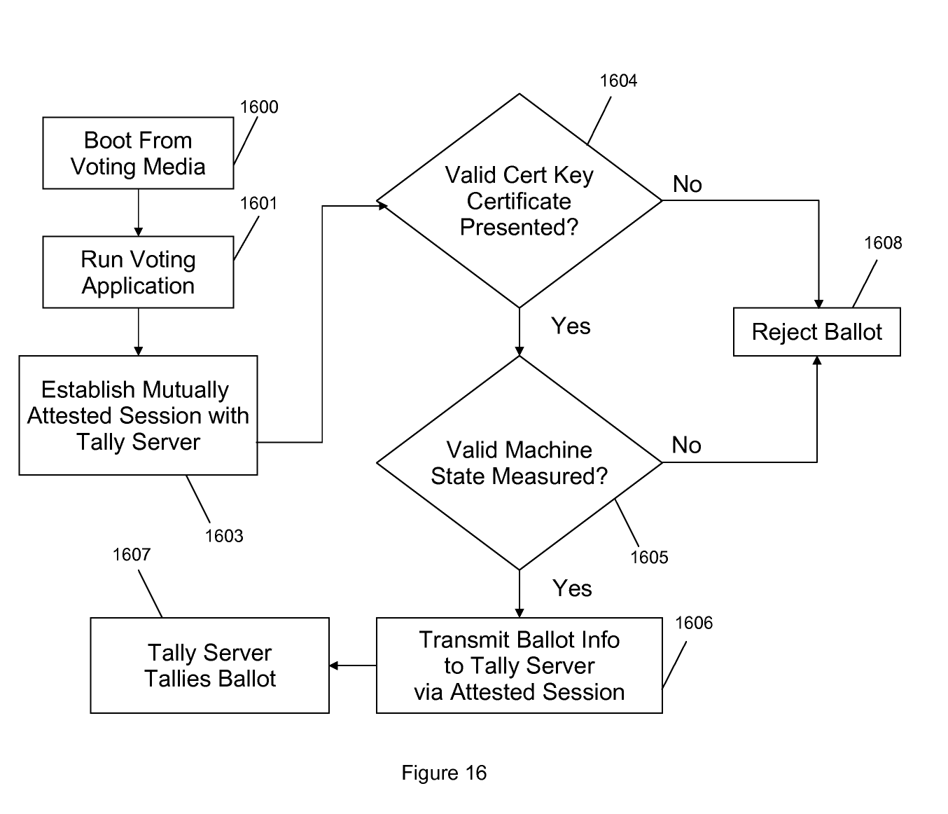

FIG. 16 illustrates the security steps that are taken when casting a ballot during an election using a Cert Key that was generated using the procedure shown in FIG. 15.

The voting machine is first booted from the voting media, step 1600. During this stage, the hardware and software components of the machine are measured and logged. The voting application runs in the trusted context, step 1601, and the voter casts the ballot. The voting machine establishes an attested session with the vote tally server, step 1603. The vote tally server cryptographically determines whether the Cert Key certificate is valid, step 1604. If so, then the vote tally server determines whether the measurements and logs presented by the voting machine in the attestation match the measurements and logs expected, step 1605. If the Cert Key certificate is invalid, then the ballot is rejected, step 1608. If the measurements or logs do not match the values expected, then the ballot is rejected, step 1608. If the Cert Key certificate is valid and the measurements and logs are valid, then the voting machine transmits its ballot to the tally server via the attested session, step 1606. The tally server tallies the authenticated ballot, step 1607.

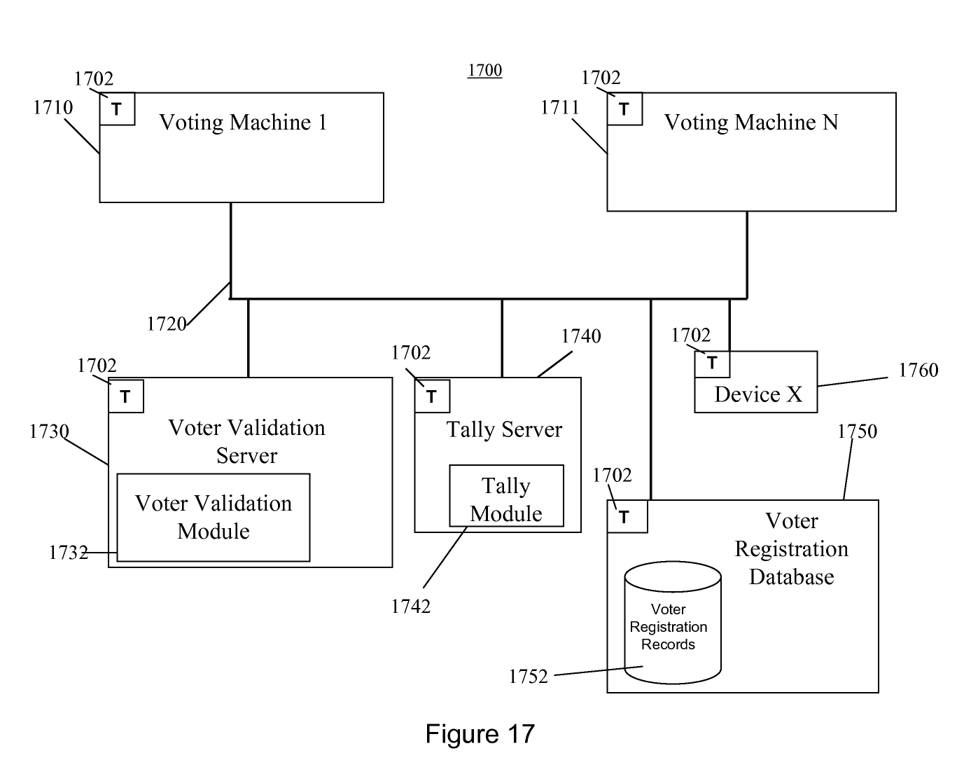

FIG. 17 shows an generic electronic voting system using a Trusted Computing Platform 1700, though it can be appreciated that many other configurations are possible (five of which are described in FIGS. 2, 3, 10, 11, and 12).

In FIG. 17, every device that participates in or interacts with the voting system must be executing in a trusted state as indicated by component 1702 in each component. Component 1702 represents the root of trust in each device in voting system 1700. Typically, the root of trust is a hardware component embedded in a device that allows the device to accurately report its identity and its state when challenged. Once such a device is correctly configured, its reporting ability cannot be subverted by software means alone unless a cryptanalysis attack is successful. In devices that implement the Trusted Computing Group standards, the Trusted Computing Module (TPM) is the main component of the root of trust.

The configuration in FIG. 17 includes one or more Voting Machines 1710, 1711. Each Voting Machine contains all the function required to display ballots and interact with voters.

The Voting Machines are connected to wired or wireless network 1720, which allows the Voting Machines 1710, 1711 to communicate with the Voter Validation Server 1730. This server runs as a trusted computing platform and services voter validation requests from voting machines attached to the network. The voter validation server includes the voter validation module 1732, which generates voter authorization tokens and determines whether a particular voter is eligible to vote in an election.

FIG. 17 also shows a Tally Server 1740 which is used to tally votes as ballots are cast, and its associated Tally Module 1742, which performs the actual tallying. Voter Registration Database 1750 is also included along with its Voter Registration Records 1752. The Voter Registration Database holds the Voter Registration Records on some storage medium, internal, external, or portable. Device X 1760 is a placeholder for one or more ancillary devices or servers that may be part of the trusted electronic voting system. For example, these ancillary devices might be one or more tally servers, verification subsystem servers, printers, biometric readers, or bar code readers, or a portable storage reader, but are not limited to those listed. No matter what function the ancillary devices provide, they must all be part of the trusted computing platform.

During elections, voters typically begin the voting process by receiving authorization to vote from the Voter Validation Server 1730. This process usually includes authenticating the identity of the voter and then checking that the voter can participate in the election according to the rules of the election. In validating the voter, the voter validation module may communicate directly with the Voter Registration Database 1750, querying records from the database to determine whether the voter is eligible to vote in the election. Once a voter is authorized, authorization information in the form of an authorization token may be communicated to one or more devices in the system. This communication may use the wired or wireless network, 1720, to provide an electronic channel between Voter Validation Server 1730 and other devices. Non-electronic protocols, however, can also be used to allow authorized voters to proceed to a Voting Machine machine. For example, a simple protocol is to just deny physical access to Voting Machines to unauthorized voters. In this case, Voter Validation Server 1730 does not need to be connected to network 1720, though the server still needs to be a TCP running in a trusted state.

Once authorized, a voter uses a Voting Machine to review a ballot and make selections. When the voter has made his selections, he uses the Voting Machine controls to cast his ballot. This action causes the vote to be tallied on Tally Server 1740. The tally module 1742 will aggregate the votes cast by voters from voting machines 1710, 1711 using network 1720.

This process of ballot casting usually requires communication between different components of a trusted electronic voting system over network 1720. All components in the system run as a TCP and each component attests that it is executing in trusted state before it communicates with any other component. In addition, cryptographic techniques are used to assure the integrity and, where necessary, the confidentiality of data during transmission over network 1720. Cryptographic techniques are also used to assure the integrity and confidentially of data when it stored.

It can be appreciated that the embodiment shown in FIG. 17 illustrates one configuration of a trusted electronic voting system, but many variations are possible. For instance, the servers that are shown as separate entities in FIG. 17 could execute on the same physical server and, therefore, share the some root of trust.

In the embodiment described above, each device runs on a trusted computing platform that allows the device to participate in the trusted electronic voting system only if (1) the device is executing in its valid election configuration and (2) the device can attest to other devices that it is in its valid election configuration. Any communication between devices in the system takes places after the devices have mutually attested. Communication channels cryptographically guarantee the integrity and, where necessary, the confidentially, of transmitted data. A precinct refers to a polling place where people go to cast their votes.

It can be appreciated that there are many configurations that could be envisioned for the embodiment described above. In another embodiment, a precinct voting system consists of at least one trusted vote input device and supporting manual processes. The input device might be a computer with a touch screen display, or an optical reader, or a device with customized hardware controls, or any other type of electronic input device. The input device tallies and records voter selections.

In another embodiment, a precinct voting system consists of at least one trusted vote input device, a trusted voter validation device, and supporting manual processes. A database of registered voters may reside on the trusted voter validation device or on another trusted device. In either case, communication between the voter validation device and the registration database is secure because they both run as part of trusted computing platforms.

In another embodiment, a precinct voting system consists of at least one trusted vote input device, a trusted vote tallying server, and supporting manual processes. The tally server collects voter selections from input devices and tallies the precinct results for the election.

In another embodiment, a precinct voting system consists of at least one trusted vote input device, a trusted voter validation device, a trusted vote tallying server, and supporting manual processes.

In another embodiment, a precinct voting system consists of at least one trusted vote input device, an optional trusted voter validation device, a trusted vote tallying server that does not reside in the precinct, and supporting manual processes. Like all trusted devices, the remote trusted vote tallying server only operates if it is in its trusted election configuration.

In another embodiment, any configuration of a precinct voting system can include a trusted third party server that can be located at the precinct or at a remote location. This trusted third party server runs on a trusted computing platform and provides device identity checking functions to other system components.

In another embodiment, some or all of the source code of the trusted electronic voting system can be accessible to computer hardware, firmware, software, and security experts, or to the public in general, to increase confidence in the correctness of the system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

We claim:

1. An apparatus for executing a trusted electronic voting system under the control of an election authority comprising:
a. at least one electronic voting machine;
b. an election configuration for said voting machine in said electronic voting system; and
c. a trusted computing platform for said voting machine in said electronic voting system.

2. The apparatus of claim 1 further comprising a tally module as part of said voting machines.

3. The apparatus of claim 1 further comprising a procedure to detect whether said voting machines are in said election configuration.

4. The apparatus of claim 1 further comprising a procedure to exclude from an election any said voting machine that is not in said election configuration.

5. The apparatus of claim 1 whereby a pre-election process is controlled by an election authority that uses a device registration server to establish said election configuration for said voting machines in said electronic voting system.

6. The apparatus of claim 5 further comprising a server, whereby said device registration server is used to issue cryptographic certificates and keys to said voting machines.

7. The apparatus of claim 6 where said device registration server can use a communication channel to distribute previously issued certificates and keys during an election.

8. The apparatus of claim 5 whereby said election configuration specifies the precise firmware and software that said voting machines must run during said election.

9. The apparatus of claim 1 whereby said trusted computing platform is implemented using open source software and commodity hardware.

10. The apparatus of claim 9 whereby certification of components of said electronic voting systems is performed by a consortium of technical experts whose work product is freely and publicly available.

11. The apparatus of claim 1 further comprising at least one ancillary device running on a trusted computing platform, said ancillary device interacts using a communication channel with other devices of said trusted electronic voting system.

12. The apparatus of claim 11 further comprising a procedure to detect whether said devices are in said election configuration.

13. The apparatus of claim 11 further comprising a procedure to exclude from an election any device that is not in said election configuration.

14. The apparatus of claim 11 whereby a pre-election process is controlled by an election authority that establishes said election configuration for said devices in said electronic voting system.

15. The apparatus of claim 14 further comprising a device registration server, whereby said device registration server is used to issue cryptographic certificates and keys to said devices.

16. The apparatus of claim 15 whereby said device registration server can distribute previously issued certificates and keys during an election.

17. The apparatus of claim 14 whereby said election configuration specifies the precise firmware and software that said devices must run during said election.

18. The apparatus of claim 11 whereby communication between said devices during an election only takes place if each of said devices are communicating in said election configurations.

19. The apparatus of claim 11 further comprising one or more communication channels allowing said devices to exchange data with cryptographically guaranteed integrity.

20. The apparatus of claim 11 further comprising one or more communication channels allowing said devices to exchange data with cryptographically guaranteed confidentiality.

21. The apparatus of claim 11 whereby said trusted computing platform is implemented using open source software and commodity hardware.

22. The apparatus of claim 21 whereby certification of said components of said electronic voting systems is performed by a consortium of technical experts whose work product is freely and publicly available.

23. The apparatus of claim 1 whereby said devices execute as trusted computing platforms that conform to a standard specification for trusted computed platforms.
